(19) United States
(12) Patent Application Publication
(10) Pub. No.: US 2022/0082023 A1
(43) Pub. Date: Mar. 17, 2022

(54) TURBINE BLADE WITH NON-AXISYMMETRIC FORWARD FEATURE

(71) Applicant: General Electric Company, Schenectady, NY (US)

(72) Inventors: Moorthi Subramaniyan, Bangalore (IN); Adam John Fredmonski, Simpsonville, SC (US)

(21) Appl. No.: 17/025,100

(22) Filed: Sep. 18, 2020

(30) Foreign Application Priority Data
Sep. 15, 2020 (IN) 202011039976

(51) Int. Cl. F01D 5/14; F01D 5/18; F01D 5/08

(52) U.S. Cl. CPC F01D 5/143; F05D 2240/30; F01D 5/081; F01D 5/187

(57) ABSTRACT

Turbine blades with non-axisymmetric forward features are provided. A turbine blade may include a platform and an airfoil extending radially outward from the platform and configured to extend into a fluid flowpath. The airfoil separates an upstream portion of the fluid flowpath from a downstream portion of the fluid flowpath. A sealing member extends axially from the platform toward a stationary nozzle adjacent the platform and separates the fluid flowpath from a wheel space. The platform may have a forward face between the sealing member and the airfoil and, optionally, a forward axial face between the forward face and the airfoil. The forward face or forward axial face may face the upstream portion of the fluid flowpath and may have a profile that is non-axisymmetric with respect to its centerline axis.

### TECHNICAL FIELD

Embodiments of the present disclosure relate generally to rotary machines and, more particularly, to forward features of a turbine blade for controlling fluid flows and temperatures near the turbine blade to reduce losses that may arise from temperature accumulation in spaces near or below the turbine blade structure.

### BACKGROUND

Turbines employ rows of rotating blades on the wheels or disks of a rotor assembly, which alternate with rows of stationary vanes on a stator or nozzle assembly. These alternating rows extend axially along the rotor and stator and allow combustion gases or steam to turn the rotor as the combustion gases or steam flow therethrough.

Axial and/or radial openings at the interface between rotating blades and stationary nozzles can allow hot combustion gases or steam to exit the main flow and radially enter the intervening wheel space between blade rows. In gas turbines, cooling air or “purge air” is often introduced into the wheel space between blade rows. This purge air serves to cool components and spaces within the wheel spaces and other regions radially inward from the blades as well as providing a counter flow of cooling air to further restrict incursion of hot gases into the wheel space. Nevertheless, incursion of combustion gases or steam into the wheel spaces between blade rows contributes to decreased turbine efficiency, directly and/or indirectly due to the need to purge such gases or steam.

### BRIEF DESCRIPTION

Aspects of the disclosure provide a turbine blade including: a platform; an airfoil extending radially outward from the platform and configured to extend into a fluid flowpath, wherein the airfoil separates an upstream portion of the fluid flowpath from a downstream portion of the fluid flowpath; a sealing member extending axially from the platform toward a stationary nozzle adjacent the platform, wherein the sealing member separates the fluid flowpath from a wheel space; and a forward face on the platform between the sealing member and the airfoil, and axially facing the upstream portion of the fluid flowpath, wherein a circumferential profile of a top surface of the forward face is non-axisymmetric with respect to a centerline axis of the forward face.

Further aspects of the disclosure provide a turbine blade including: a platform; an airfoil extending radially outward from the platform and configured to extend into a fluid flowpath, wherein the airfoil separates an upstream portion of the fluid flowpath and a downstream portion of the fluid flowpath; a sealing member extending axially from the platform toward a stationary nozzle adjacent the platform, wherein the sealing member separates the fluid flowpath from a wheel space; and a forward face on the platform between the sealing member and the airfoil, and axially facing the upstream portion of the fluid flowpath; and a forward axial face on the platform extending from a top surface of the forward face to the airfoil, wherein an axial contour of the forward axial face is non-axisymmetric with respect to a centerline axis of the forward face.

Another aspect of the disclosure provides a turbine blade including: a platform; an airfoil extending radially outward from the platform, the airfoil configured to extend into a fluid flowpath, wherein the airfoil separates an upstream portion of the fluid flowpath from a downstream portion of the fluid flowpath; a sealing member extending axially from the platform toward a stationary nozzle, wherein the sealing member separates the fluid flowpath from a wheel space; a forward face on the platform between the sealing member and the airfoil, and axially facing the upstream portion of the fluid flowpath, wherein a circumferential profile of a top surface of the forward face is non-axisymmetric with respect to a centerline axis of the forward face; and a forward axial face on the platform extending from the top surface of the forward face to the airfoil, wherein an axial contour of the forward axial face is non-axisymmetric with respect to the centerline axis of the forward face.

### BRIEF DESCRIPTION OF THE DRAWINGS

These and other features of the present turbine blades will be more readily understood from the following detailed description taken in conjunction with the accompanying drawings that depict various embodiments of the disclosure, in which:

FIG. 1 shows a schematic cross-sectional view of a portion of a conventional turbine blade;

FIG. 2 shows a perspective view of a turbine blade according to embodiments of the disclosure;

FIG. 3 shows a plot comparing a turbine blade having an axisymmetric forward feature with a turbine blade having a non-axisymmetric forward feature;

FIG. 4 shows a perspective view of multiple turbine blades with various non-axisymmetric forward features according to embodiments of the disclosure;

FIG. 5 shows a perspective view of a turbine blade according to further embodiments of the disclosure; and

FIG. 6 shows a schematic block diagram illustrating portions of a multi-shaft power plant system where a turbine blade according to embodiments of the present disclosure is deployed.

It is noted that the drawings of the invention are not to scale. The drawings are intended to depict only typical aspects of the turbine blade and its features and therefore should not be considered as limiting the scope of the invention. In the drawings, like numbering represents like elements among the drawings.

### DETAILED DESCRIPTION

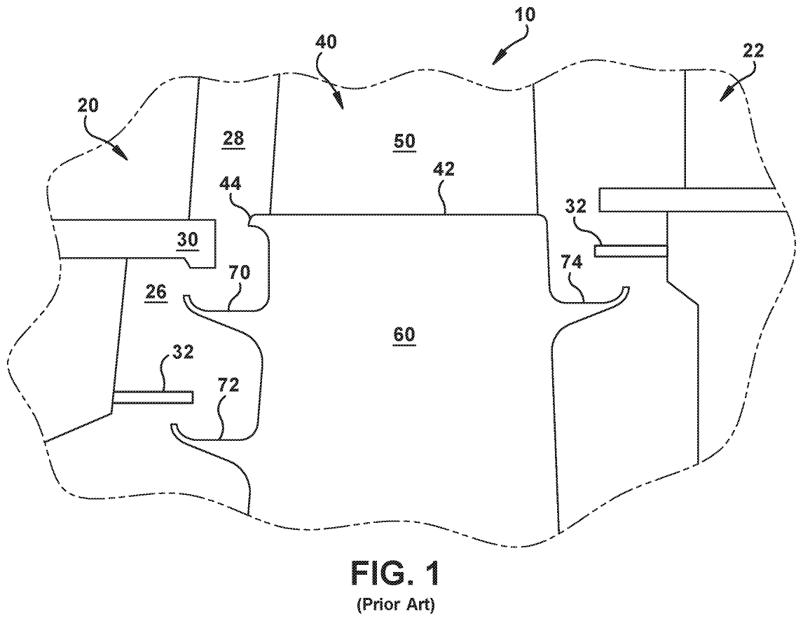

Turning now to the drawings, FIG. 1 shows a schematic cross-sectional view of a portion of a gas turbine 10 including a blade 40 disposed between two adjacent nozzles, e.g., a first stage nozzle 20 (sometimes known as a “stationary blade”) and a second stage nozzle 22. Blade 40 extends radially outward from an axially extending rotor (not shown), as will be recognized by one skilled in the art. Blade 40 includes a platform 42, and an airfoil 50 extends radially outward from platform 42. Platform 42 may have a shank portion 60 that extends radially inward with respect to airfoil 50.

Shank portion 60 includes a pair of sealing members 70, 72 (sometimes referred to as “angel wings”) extending axially outward toward first stage nozzle 20 and a sealing member 74 extending axially outward toward second stage nozzle 22. It should be understood that differing numbers and arrangements of sealing members are possible. The number and arrangement of sealing members described herein are provided merely for purposes of illustration.

As can be seen in FIG. 1, nozzle surface 30 and discourager member 32 extend axially from first stage nozzle 20 and are disposed radially outward from sealing members 70 and 72, respectively. As such, nozzle surface 30 overlaps but does not contact sealing member 70, and discourager member 32 overlaps but does not contact sealing member 72. A similar arrangement is shown with respect to discourager member 32 of second stage nozzle 22 and sealing member 74. In the arrangement shown in FIG. 1, during operation of the turbine, a quantity of purge air may be disposed between, for example, nozzle surface 30, sealing member 70, and platform lip 44, thereby restricting both escape of purge air into hot gas flowpath 28 and incursion of hot gases from hot gas flowpath 28 into wheel space 26.

While FIG. 1 shows blade 40 disposed between first stage nozzle 20 and second stage nozzle 22, such that blade 40 represents a first stage blade, this is merely for purposes of illustration and explanation. The principles and embodiments of the invention described herein may be applied to a blade of any stage in the turbine with the expectation of achieving similar results.

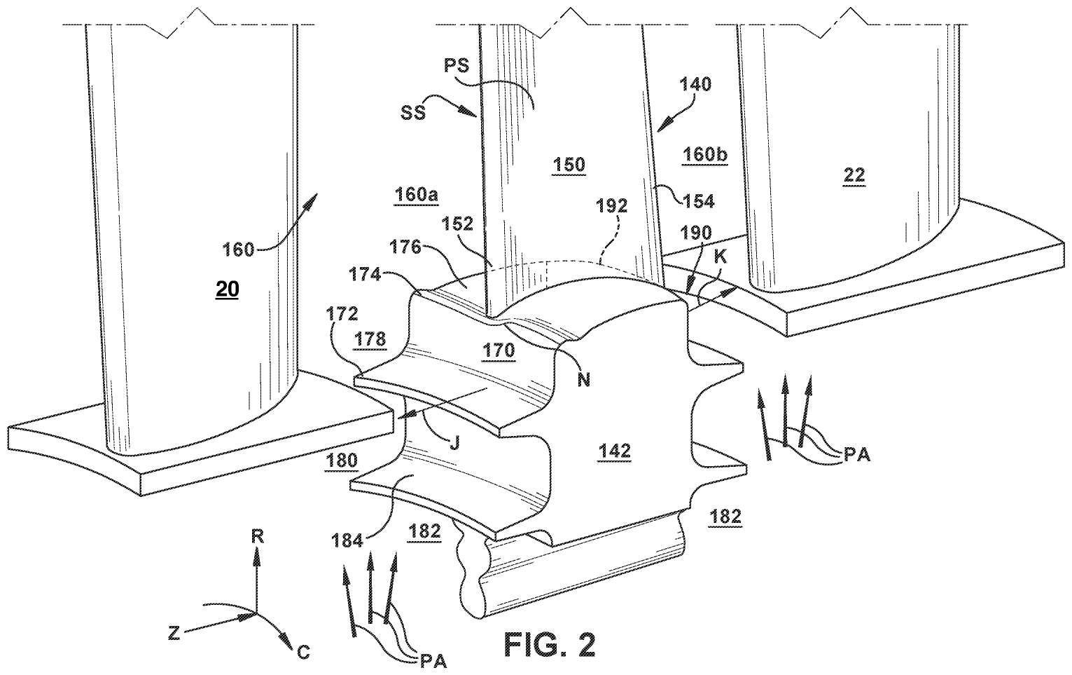

FIG. 2 shows a perspective view of a portion of a turbine blade 140 with a non-axisymmetric forward feature according to embodiments of the disclosure. Turbine blade 140 is depicted in FIG. 2 as being between first stage nozzle 20 and second stage nozzle 22, but turbine blade 140 can be located in any conceivable location of a turbomachine where rotating blades are desired. Turbine blade 140 can include a platform 142 and an airfoil 150 extending radially outward (i.e., at least partially along radial axis R) from platform 142. As can be seen, airfoil 150 includes a leading edge 152 (e.g., nearer to first stage nozzle 20) and a trailing edge 154 (e.g., nearer to second stage nozzle 22). Airfoil 150 can extend into a fluid flowpath 160, which may include an upstream portion 160a upstream of airfoil 150 and a downstream portion 160b downstream of airfoil 150.

Platform 142 may include a forward face 170 nearer leading edge 152 than trailing edge 154. In this case, leading edge 152 of airfoil 150 may face axially toward (i.e., along axial axis Z) forward face 170. Forward face 170 may extend radially from a sealing member 172 to a top surface 174 and may face toward upstream portion 160a of fluid flowpath 160. Top surface 174 of forward face 170 (similar to platform lip 44 of FIG. 1) separates forward face 170 from a top face 176 of platform 142. In this case, airfoil 150 can be mounted on, and/or may extend radially outward from, top face 176 of platform 142.

Sealing member 172 may be formed from platform 142, e.g., by being machined from a larger precursor structure, and/or produced via any known or later-developed method. For instance, sealing member 172 and/or other distinct features of platform 142 may be formed by casting and/or additive manufacture. However formed, sealing member 172 may extend axially (i.e., along radial axis Z) toward first stage nozzle 20. Sealing member 172 also may separate a platform space 178 within upstream portion 160a from other spaces radially beneath sealing member 172 (i.e., in the negative direction along radial axis R). Such spaces may include, e.g., a buffer space 180 radially between upstream portion 160a and a wheel space 182. An additional sealing member 184 can radially separate buffer space 180 from wheel space 182.

Platform 142 may include forward features that are shaped to be non-axisymmetric about a centerline axis of corresponding portions of platform 142. One such forward feature may include, e.g., top surface 174 of forward face 170. Forward face 170 may have a centerline axis J extending axially outward from platform 142, e.g., toward first stage nozzle 22. Turbine blade 140 may be distinct from conventional blade structures, e.g., by having at least one forward feature that is non-axisymmetric with respect to centerline axis J. The term “non-axisymmetric” refers to any portion of platform 142 that is not symmetric about the location of centerline axis J. According to one example, such a forward feature may include a circumferential profile of top surface 174. The term “circumferential profile” may refer to the pathway along which top surface 174 extends, at least partially with respect to circumferential axis C.

An axisymmetric circumferential profile may include, e.g., a linear or arcuate path that is symmetrical about, or centered with respect to centerline axis J. Such profiles may include, e.g., arcuate, piecewise-defined linear, and/or other profiles along circumferential axis C that are symmetrical about centerline axis J. In embodiments of the disclosure, top surface 174 is non-axisymmetric about centerline axis J. For instance, in the example of FIG. 2, top surface 174 includes a nodule N that is nearer to one circumferential end of platform 142 than the other. The term “nodule” as used herein may refer to at least one raised portion, depressed portion, slope, bump, recess, and/or other similar feature that may be arcuate and/or non-arcuate discrepancies from the profile of another surface region. Regardless of shape, nodule N may be closer to a pressure side surface PS than a suction side surface SS of airfoil 150 (as shown), or vice versa.

It is understood that top surface 174 may include multiple nodules, e.g., several that are closer to suction side surface SS than pressure side surface PS of airfoil 150. Any number or arrangement of nodules is possible, provided that such nodules and/or other non-linear and/or arcuate portions of top surface 174 are not symmetric about centerline axis J. In further examples, each nodule N and/or other non-arcuate or non-linear portion of top surface 174 may have a profile that is itself non-axisymmetric with respect to centerline axis J. As shown in FIG. 2, nodule N has both a non-axisymmetric profile and a non-symmetric position within top surface 174 to illustrate both of these possibilities.

The presence of nodule N, and/or other portions of top surface 174 that are non-axisymmetric about centerline axis J, may provide a circumferential profile that facilitates efficient use of purge air PA and that avoids ingestion of hot gas from fluid flowpath 160, in spaces alongside turbine blade 140. This attribute of turbine blade 140 provides, e.g., reduced gas temperature at forward face 170 and top surface 174 of platform 142. The reduced gas temperature, in turn, reduces total purge flow to spaces adjacent turbine blade 140 and thus improves efficiency of a turbine system. The non-axisymmetric portions of top surface 174, by being located on forward face 170, may provide preferable heat concentration in turbine blade 140 without significantly interfering with the flow of operative fluid(s) in fluid flowpath 160.

The non-axisymmetric feature(s) of turbine blade 140 may be limited to only one of its features, e.g., forward face 170. According to an example, platform 142 may include an anterior face 190 that is axially opposite forward face 170 and that faces downstream portion 160b of fluid flowpath 160. Anterior face 190 may itself include a top surface 192 (shown in phantom) that is distinct from top surface 174 of forward face 170. Top surface 192 of anterior face 190 may be axisymmetric about a centerline axis K of anterior face 190. Thus, top surface 192 may be free of any nodules N, such as those shown by example in top surface 174.

In further examples, top surface 192 may include one or more nodules N, but such nodules may be distinct from those in top surface 174 by being arranged symmetrically about centerline axis K. Thus, no matter how top surface 192 is shaped, it may have a profile that is geometrically distinct from top surface 174 of forward face 170 by being axisymmetric about its centerline axis K.

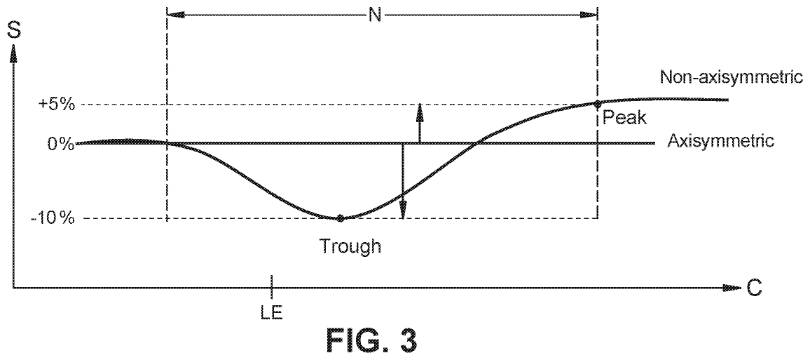

FIG. 3 provides a plot for comparing portions of forward features (e.g., platform lip 44 (FIG. 1)) for a conventional turbine blade with forward features (e.g., top surface 174 (FIG. 2)) of turbine blade 140 (FIG. 2). Axis “C” indicates the circumferential position of top surface 174 (or platform lip 44) from one side of blade 140 to another, while axis “S” indicates the height of top surface 174 relative to top face 176 of platform 142 in the radial direction R. Interval “N” in FIG. 3 denotes the span of one nodule “N” in an example implementation. The plot shown in FIG. 3 and labeled “Non-axisymmetric” may represent a portion of top surface 174 as depicted in FIG. 2. In a conventional turbine blade, a top surface of the forward face (i.e., platform lip 44) may be substantially linear and thus axisymmetric about centerline axis J (shown in FIG. 2). In this case, as plotted in FIG. 3, the top surface of a conventional turbine blade may be fixed at approximately zero percent difference in height with respect to a mean height of platform 142 relative to its bottom-most point on radial axis R. Such plot is labeled “Axisymmetric.”

In embodiments of present turbine blade 140, however, nodule N will cause top surface 174 to have a trough that is about ten percent less than the median height of platform 142 along axis S (i.e., in the radial direction R). Nodule N may also cause top surface 174, at a different circumferential position, to have a peak that is about five percent more than the median height of platform 142 in the radial direction R. In this case, the peak of top surface 174 is located nearer to airfoil 150 than the trough of top surface 174. According to the example plot depicted in FIG. 3, the peak and trough of top surface 174 may be circumferentially distal to the location of leading edge 152 (FIG. 2) of airfoil 150, indicated by mark “LE” in the example plot.

In further examples, the peak and trough of top surface 174 may be in opposite positions, or located elsewhere along circumferential axis C. It is also understood that further implementations may include multiple peaks and multiple troughs (e.g., formed by respective nodules N within top surface 174). In any case, FIG. 3 demonstrates that top surface 174 may be non-axisymmetric with respect to centerline axis J.

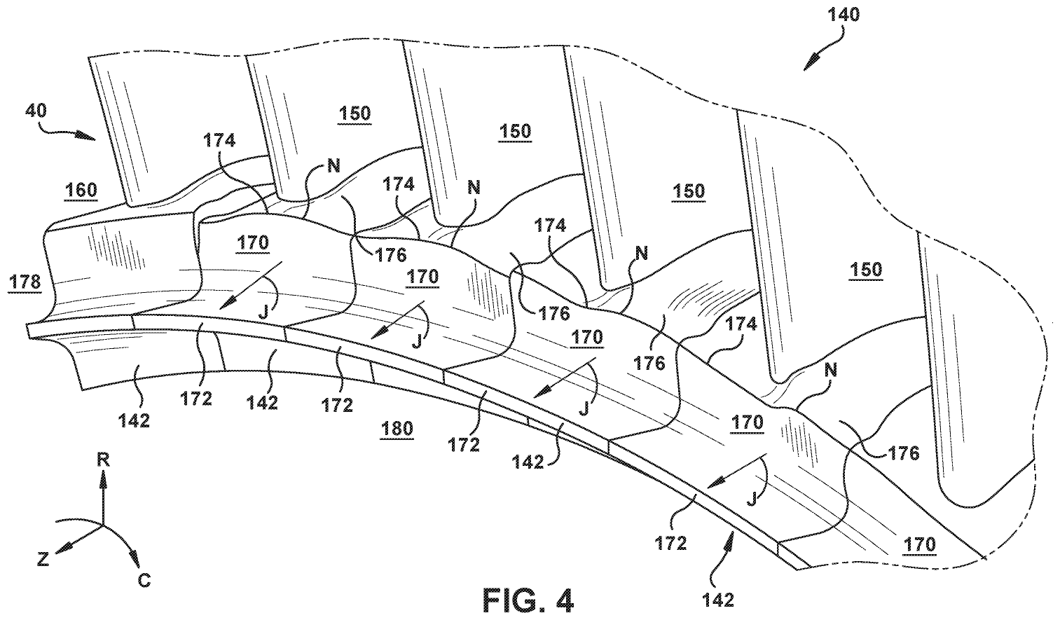

FIG. 4 depicts several turbine blades 140 side-by-side together with one conventional turbine blade 40 to further illustrate differences between embodiments of the disclosure and differences between turbine blade(s) 140 according the embodiments of the disclosure and conventional turbine blade 40. It is understood that the depiction in FIG. 4 is solely for comparison and that multiple configurations of turbine blade 140 may not be deployed together in one machine and/or together with conventional turbine blade(s) 40.

FIG. 4 depicts four different turbine blades 140 each having a respective forward face 170 with a distinctly shaped top surface 174. As shown, each top surface 174 may have a respective nodule N that causes each top surface 174 of turbine blades 140 to be non-axisymmetric with respect a corresponding centerline axis J of forward face 170. By contrast, turbine blade 40 lacks any nodules N and, more significantly, has an axisymmetric profile on its forward face. It is thus understood that top surface 174 of forward face 170 can be formed using any conceivable shape, profile, etc., such that it has a non-axisymmetric profile along circumferential axis C with respect to the corresponding centerline axis J of forward face 170. It is also understood, as shown in FIG. 4, that the location where airfoil 150 meets top face 176 may vary based on the shape, number, and/or location of nodule(s) N within top surface 174.

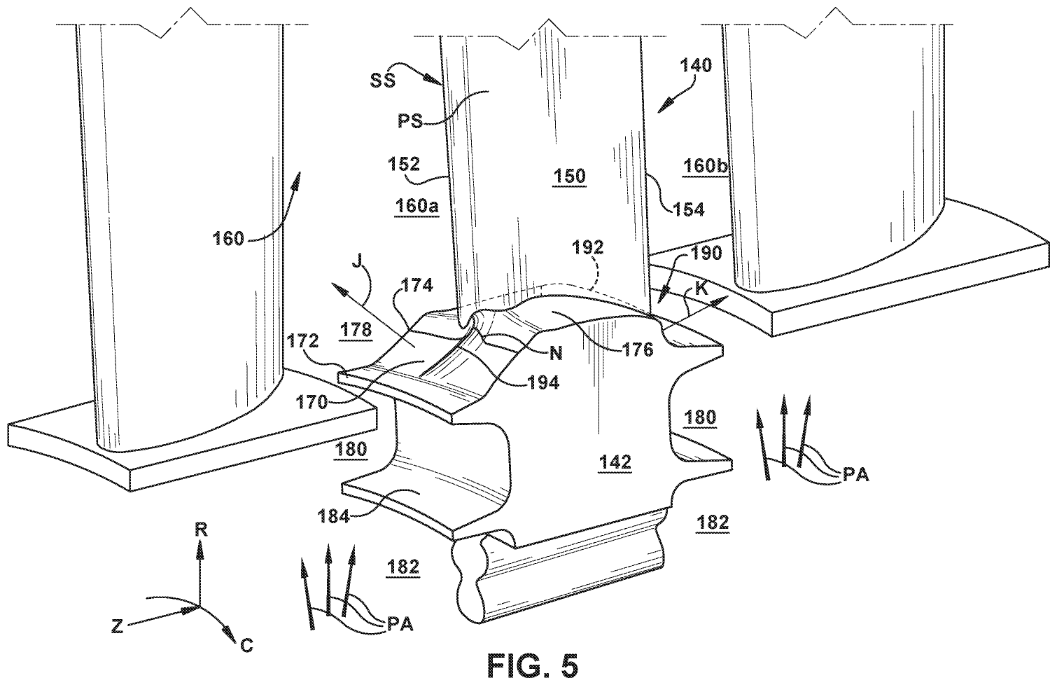

FIG. 5 depicts a further example of turbine blade 140 with various additional features. Turbine blade 140 may include several of the same or similar features as those discussed in other embodiments (e.g., turbine blade(s) 140 as depicted in FIGS. 2, 4), except where specifically noted herein. The various features of turbine blade 140 illustrated in FIG. 5 can be implemented together with, or separately from, those in other embodiments. In some implementations, platform 142 may include a forward axial face 194 extending from top face 176 onto at least a portion of forward face 170. In some cases, forward axial face 194 may extend from airfoil 150 to sealing member 172. Forward axial face 194 additionally may be directed toward upstream portion 160a of fluid flowpath 160.

However embodied, forward axial face 194 may take the form of an additional surface and/or raised area positioned axially between a portion (e.g., leading edge 152) of airfoil 150 and sealing member 172. Forward axial face 194 may have any conceivable axial contour that is non-axisymmetric with respect to centerline axis J of forward face 170. Axis J is shown to face a different direction than in FIG. 2, due to differences in the structure of forward face 170. In FIG. 5, forward axial face 194 extends substantially axially along a portion of forward face 170, but curves circumferentially toward suction side surface SS of airfoil 150 along a portion of forward face 170 and top surface 174 that is nearer to airfoil 150. In this configuration, the axial contour of forward axial face 194 is not symmetric about centerline axis J of forward face 170 and thus is non-axisymmetric as described herein. In addition, one axial end of forward axial face 194 may contact a portion of pressure side surface SS at a location that is axially offset from leading edge 152 (e.g., between leading edge and trailing edge 154).

Further embodiments of forward axial face 194 may extend across top face 176 with any conceivable axial contour that is non-axisymmetric about centerline axis J, and such axial contours may include linear axial pathways and/or non-linear axial pathways. Regardless of the shape and position of forward axial face 194, forward face 170 optionally may feature top surface 174 with a circumferential profile that is also non-axisymmetric with respect to centerline axis J. In such cases, the location of one or more nodules N in top surface 174 may coincide with the location of forward axial face 194 on platform 142. It is also understood that forward axial face 194 alternatively may be positioned on platform 142 where top surface 174 does not feature a non-axisymmetric circumferential profile. Similar to other embodiments described herein, however, turbine blade 140 may include anterior face 190 with top surface 192, in which a circumferential profile of top surface 192 is axisymmetric about centerline axis K of anterior face 190.

Although embodiments of turbine blade 140 are described as being positioned between first stage nozzle 20 and second stage nozzle 22, it is understood that turbine blade 140 can be placed between nozzles of other stages and/or adapted for other portions of a turbomachine. Thus, turbine blade 140 can be operable for deployment within fluid flowpath 160 to reduce the gas temperature at, or near, forward face 170 and/or forward axial face 194.

Turbine blade 140 is distinct from conventional rotating blade structures, e.g., by including non-axisymmetric geometries of forward face 170 (specifically, top surface 174) and/or forward axial face 194 on forward-facing axial surfaces of platform 142. Forward face 170 and/or forward axial face 194 with non-axisymmetric features can be adjacent a purge air-cooled space (e.g., platform space 178 and/or buffer space 180) at the top surface of the forward face 170, thereby causing a more significant difference in temperature (e.g., at least approximately 200° F.) between portions of platform 142 that are adjacent airfoil 150 and portions of platform 142 that are adjacent sealing member 172. Such differences in temperature may provide improvements in operating efficiency as compared to conventional rotating blade structures, e.g., at least approximately 0.20% efficiency improvement in turbine stages where platform 142 is used. Moreover, such differences in temperature may reduce the amount of purge air needed to cool certain heat-sensitive regions of platform 142.

It is understood that in various embodiments, many sizes, shapes, profiles, etc., of top surface 174 and/or forward axial face 194 of blade structure 140 may vary and may include configurations not specifically shown or described herein. Various other airfoil parameters, e.g., wall apex locations, blade pitches, widths, aspect ratios between the length and/or area of various surfaces, etc., are also possible and may further affect the shape and size of top surface 174 of forward face 170 and/or forward axial face 194. Any example values of such parameters given herein are merely illustrative of several of the many possible embodiments in accordance with the disclosure.

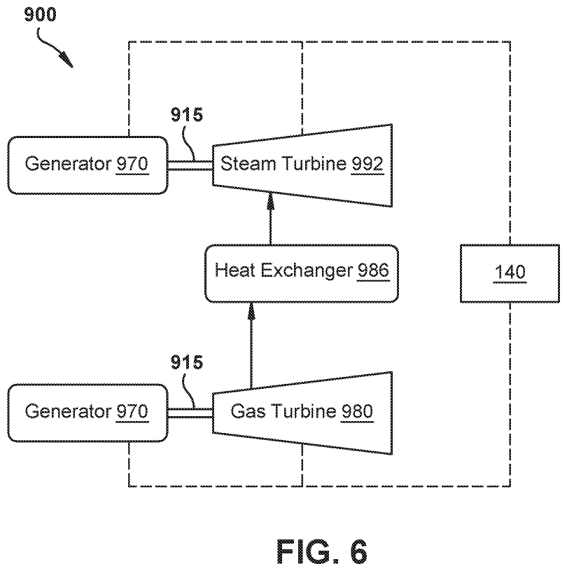

Turning to FIG. 6, a schematic view of portions of a multi-shaft combined cycle power plant 900, where turbine blade 140 may be deployed, is shown. Combined cycle power plant 900 may include, for example, a gas turbine 980 operably connected to a generator 970. Generator 970 and gas turbine 980 may be mechanically coupled by a shaft 915, which may transfer energy from a drive shaft (not shown) of gas turbine 980 to generator 970. Also shown in FIG. 6 is a heat exchanger 986 operably connected to gas turbine 980 and a steam turbine 992. Heat exchanger 986 may be fluidly connected to both gas turbine 980 and steam turbine 992 via conventional conduits (numbering omitted). Gas turbine 980 and/or steam turbine 992 may include one or more turbine blades 140 as shown and described with reference to FIGS. 2, 4, and 5, and/or other embodiments described herein. Heat exchanger 986 may be a conventional heat recovery steam generator (HRSG), such as those used in conventional combined cycle power systems.

As is known in the art of power generation, heat exchanger 986 may use hot exhaust from gas turbine 980, combined with a water supply, to create steam which is fed to steam turbine 992. Steam turbine 992 may optionally be coupled to a second generator system 970 (via a second shaft 915). It is understood that generators 970 and shafts 915 may be of any size or type known in the art and may differ depending upon their application or the system to which they are connected. Common numbering of the generators and shafts is for clarity and does not necessarily suggest these generators or shafts are identical. In further embodiments, a single shaft combined cycle power plant 990 may include a single generator 970 (not shown) coupled to both gas turbine 980 and steam turbine 992 via a single shaft 915 (not shown). Steam turbine 992 and/or gas turbine 980 may include one or more turbine blades 140 shown and described with reference to FIGS. 2, 5, and 5, and/or other embodiments described herein.

The apparatus and devices of the present disclosure are not limited to any one particular engine, turbine, jet engine, generator, power generation system or other system and may be used with aircraft systems, other power generation systems (e.g., combined cycle, simple cycle), and/or other systems (e.g., nuclear reactor, etc.). Additionally, the apparatus of the present disclosure may be used with other systems not described herein that may benefit from the increased efficiency of the apparatus and devices described herein.

In various embodiments, components described as being “coupled” to one another can be joined along one or more interfaces. In some embodiments, these interfaces can include junctions between distinct components, and in other cases, these interfaces can include a solidly and/or integrally formed interconnection. That is, in some cases, components that are “coupled” to one another can be simultaneously formed to define a single continuous member. However, in other embodiments, these coupled components can be formed as separate members and be subsequently joined through known processes (e.g., fastening, ultrasonic welding, bonding).

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any related or incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A turbine blade comprising:
a platform;
an airfoil extending radially outward from the platform and configured to extend into a fluid flowpath, wherein the airfoil separates an upstream portion of the fluid flowpath from a downstream portion of the fluid flowpath;
a sealing member extending axially from the platform toward a stationary nozzle adjacent the platform, wherein the sealing member separates the fluid flowpath from a wheel space;
a forward face on the platform between the sealing member and the airfoil, and axially facing the upstream portion of the fluid flowpath, wherein a circumferential profile of a top surface of the forward face is non-axisymmetric with respect to a centerline axis of the forward face, and wherein a height of the top surface of the forward face relative to a height of a top surface of the platform varies in a radial direction; and
an anterior face on the platform axially opposite the forward face, and axially facing the downstream portion of the fluid flowpath, wherein a circumferential profile of a top surface of the anterior face is axisymmetric with respect to a centerline axis of the anterior face,
wherein the top surface of the forward face includes a radial trough and a radial peak, and wherein a radial distance between a bottom of the radial trough and the airfoil in the radial direction is greater than a radial distance between a top of the radial peak and the airfoil in the radial direction.

2. The turbine blade of claim 1, wherein the forward face of the platform between the sealing member and the platform of the airfoil defines a platform space of the fluid flowpath axially between the platform and the stationary nozzle.

3. The turbine blade of claim 1, further comprising a buffer space defined between the fluid flowpath and the wheel space, wherein the sealing member radially separates the forward face of the platform from the wheel space and the buffer space.

4. (canceled)

5. (canceled)

6. The turbine blade of claim 1, wherein the forward face is adjacent a purge air-cooled space adjacent the turbine blade.

7. The turbine blade of claim 1, wherein a leading edge of the airfoil faces axially toward the forward face.

8. (canceled)

9. A turbine blade comprising:
a platform;
an airfoil extending radially outward from the platform and configured to extend into a fluid flowpath, wherein the airfoil separates an upstream portion of the fluid flowpath and a downstream portion of the fluid flowpath;
a sealing member extending axially from the platform toward a stationary nozzle adjacent the platform, wherein the sealing member separates the fluid flowpath from a wheel space; and
a forward face on the platform between the sealing member and the airfoil, and axially facing the upstream portion of the fluid flowpath;
a forward axial face on the platform extending from a top surface of the forward face to the airfoil, wherein an axial contour of the forward axial face is non-axisymmetric with respect to a centerline axis of the forward face, and wherein a height of the top surface of the forward face relative to a height of a top surface of the platform varies in a radial direction; and
an anterior face on the platform axially opposite the forward face, and axially facing the downstream portion of the fluid flowpath, wherein a circumferential profile of a top surface of the anterior face is axisymmetric with respect to a centerline axis of the anterior face,
wherein the top surface of the forward face includes a radial trough and a radial peak, and wherein a radial distance between a bottom of the radial trough and the airfoil in the radial direction is greater than a radial distance between a top of the radial peak and the airfoil in the radial direction.

10. The turbine blade of claim 9, wherein the forward face of the platform between the sealing member and the airfoil defines a platform space of the fluid flowpath radially between the platform and the stationary nozzle.

11. The turbine blade of claim 9, further comprising a buffer space defined between the fluid flowpath and the wheel space, wherein the sealing member radially separates the forward face of the platform from the wheel space and the buffer space.

12. The turbine blade of claim 9, wherein the forward axial face is adjacent a purge air-cooled space adjacent the turbine blade.

13. The turbine blade of claim 9, wherein a leading edge of the airfoil faces axially toward the forward face, and wherein the forward axial face contacts the airfoil at a location axially offset from the leading edge of the airfoil.

14. (canceled)

15. A turbine blade comprising:
a platform;
an airfoil extending radially outward from the platform, the airfoil configured to extend into a fluid flowpath, wherein the airfoil separates an upstream portion of the fluid flowpath from a downstream portion of the fluid flowpath;
a sealing member extending axially from the platform toward a stationary nozzle, wherein the sealing member separates the fluid flowpath from a wheel space;
a forward face on the platform between the sealing member and the airfoil, and axially facing the upstream portion of the fluid flowpath, wherein a circumferential profile of a top surface of the forward face is non-axisymmetric with respect to a centerline axis of the forward face;
a forward axial face on the platform extending from the top surface of the forward face to the airfoil, wherein an axial contour of the forward axial face is non-axisymmetric with respect to the centerline axis of the forward face, and wherein a height of the top surface of the forward face relative to a height of a top surface of the platform varies in a radial direction; and
an anterior face on the platform axially opposite the forward face, and axially facing the downstream portion of the fluid flowpath, wherein a circumferential profile of a top surface of the anterior face is axisymmetric with respect to a centerline axis of the anterior face,
wherein the top surface of the forward face includes a radial trough and a radial peak, and wherein a radial distance between a bottom of the radial trough and the airfoil in the radial direction is greater than a radial distance between a top of the radial peak and the airfoil in the radial direction.

16. The turbine blade of claim 15, wherein the forward face of the platform between the sealing member and the airfoil defines a platform space of the fluid flowpath axially between the platform and the stationary nozzle.

17. The turbine blade of claim 15, further comprising a buffer space defined between the fluid flowpath and the wheel space, wherein the sealing member radially separates the forward face of the platform from the wheel space and the buffer space.

18. (canceled)

19. The turbine blade of claim 15, wherein the circumferential profile of the top surface of the forward face is adjacent a purge air-cooled space adjacent the turbine blade.

20. (canceled)
